(19) United States
(12) Patent Application Publication
(10) Pub. No.: US 2022/0355330 A1
(43) Pub. Date: Nov. 10, 2022

(54) PAINT ROLLER FOR EVENLY SUPPLYING PAINT

(71) Applicant: WOWCOMPANY CO.,LTD., Goyang-si, Gyeonggi-do (KR)

(72) Inventors: Sung Il KIM, Goyang-si (KR); Nam Gyun JEONG, Incheon (KR)

(73) Assignee: WOWCOMPANY CO.,LTD., Goyang-si, Gyeonggi-do (KR)

(21) Appl. No.: 17/623,490

(22) PCT Filed: Jun. 28, 2019
(86) PCT No.: PCT/KR2019/007875

§ 371 Date: Dec. 28, 2021

(30) Foreign Application Priority Data
Jun. 28, 2019 (KR) 10-2019-0077489

(51) Int. Cl. B05C 1/08

(52) U.S. Cl. CPC B05C 1/0808; B05C 1/0813

(57) ABSTRACT

The present invention relates to a paint roller for evenly supplying paint. A paint roller according to one embodiment of the present invention comprises: a cylindrical roller body having a plurality of holes; and a roller cover surrounding the outer surface of the roller body, wherein the holes are densely distributed at opposite ends of the roller body.

### TECHNICAL FIELD

The present invention relates to a paint roller for evenly supplying paint and, more particularly, to a paint roller with improved uniformity of paint distribution, by increasing a distribution of holes at opposite end of a roller body.

### BACKGROUND ART

A paint roller is a tool used to apply paint to the wall of a building or the like and, unlike a painting brush, has a construction that a worker can easily and conveniently spread the paint through a rolling motion.

Any roller typically used in the art has a round shape at opposite ends thereof, and such a shape may have a problem in that painting is not properly done at the corner of a painted surface, or the paint is concentrically applied at the beginning or to the center of the painted surface. Further, there is a disadvantage that fibers of the surface of the roller body are too fine to paint a rough surface or to be desirably used for aqueous paint.

Specifically, in accordance with the current special law for prevention of particulate matter (PM) in atmospheric environment, since a shatter-proof film must be installed during external painting and spraying is prohibited, roller painting or brush painting is mainly used. In this case, particulate matter prevention is also required.

Accordingly, technologies for automatically spraying paint by incorporating paint into a paint roller or brush, or for spraying paint by supplying paint to the roller or brush through pressure have been developed.

However, even in the above methods, if using a typical roller, there may be a problem that the paint is not evenly distributed during work, and an internal configuration or the paint roller or brush is complicated, hence not only making it difficult to manufacture the same, but also causing difficulties in working due to weight increase.

### DISCLOSURE

### Technical Problem

The present invention has been proposed to solve the above problems, and an object of the present invention is to provide a paint roller with improved workability, which uniformly supplies paint and has reduced weight.

However, problems to be solved by the present invention are not particularly limited to those mentioned above, and other objects of the present invention not specifically mentioned herein will be clearly understood by those skilled in the art from the following description.

### Technical Solution

One aspect of the present invention is to provide a paint roller, which includes: a cylindrical roller body having a plurality of holes; and a roller cover surrounding an outer surface of the roller body, wherein the holes are densely distributed at opposite ends of the roller body.

According to an embodiment, the paint roller may include the roller body in which: a support having at least one bent portion; and a hinge portion rotatably coupled to the bent portion of the support are disposed in an inner space of the roller body, as well as a cap coupled to one or opposite sides of the roller body.

According to an embodiment, the support may include: an internal passage connected to a paint feeder, through which the paint is delivered; and a plurality of surface holes through which the delivered paint is ejected.

According to an embodiment, a diameter of the cap may be larger than a diameter of the roller cover to prevent lateral scattering.

According to an embodiment, the support may be configured to support only one end of the roller body so as to be rotated.

According to an embodiment, the hinge portion may be formed of at least one selected from the group consisting of urethane foam, silicon foam and sponge.

According to an embodiment, a length of opposite ends of the roller body may range from 0.1 to 0.5 times the total length of the roller body.

According to an embodiment, the holes may be distributed by 50 to 80% in a 20% section in terms of a distance from opposite ends of the roller body.

According to an embodiment, the number of the holes may be gradually reduced from opposite ends of the roller body toward the center portion.

According to an embodiment, the holes may have a diameter increasing from the center of the roller body toward opposite ends of the roller.

According to an embodiment, a diameter of the roller body may range from 10 to 80 mm.

According to an embodiment, a length of the roller body may range from 1,000 to 5,000 mm.

According to an embodiment, a thickness of the roller cover may range from 5 to 50 mm.

### Advantageous Effects

The paint roller of the present invention may have a large number of holes densely distributed at opposite ends of a roller body in the roller, thereby having an effect of uniformly supplying paint during painting.

Further, the paint roller of the present invention is applicable to a paint pressure-feeding method, thereby being effective in preventing scattering. Further, the paint roller of the present invention is also effective in preventing lateral scattering by adjusting a diameter of the cap coupled to a lateral side of the roller.

In addition, the paint roller of the present invention may consist of lightweight materials without any separate internal device, thereby reducing weight and enabling easy operation.

### DESCRIPTION OF DRAWINGS

FIG. 1 illustrates an image showing a hole distribution on the surface of a roller body in each of Comparative Example 1 (left) and Example 1 (right), respectively.

FIG. 2 illustrates a result of observing a paint distribution of the roller body in Comparative Example 1 over time.

FIG. 3 illustrates a paint distribution of the roller body of each of Comparative Example 1 (left) and Example 1 (right), respectively, 0.8 seconds after paint ejection.

### BEST MODE

Hereinafter, exemplary embodiments of the present invention will be described with reference to the accompanying drawings. However, various alterations may be made to the embodiments, therefore, the scope of patent rights of the present invention is not limited or restricted by the above embodiments. Instead, it should be understood that all changes, equivalents and/or substitutes to the embodiments are included in the scope of the present invention.

The terms in the embodiments are used for illustrative purposes only and should not be interpreted as limiting. Singular expressions include plural expressions unless the context clearly indicates otherwise. In the present specification, terms such as “comprise (include)” or “have” are intended to designate the presence of features, numbers, steps, actions, components, parts or combinations thereof described in the specification, but it is to be understood that the possible presence or addition of one or more other features, numbers, steps, actions, components, parts or combinations thereof is not excluded in advance.

Unless otherwise defined, all terms used herein including technical or scientific terms or words have the same meanings as commonly understood by ones having ordinary skill in the art to which the embodiments belong (“those skilled in the art”). Terms as defined in a commonly used dictionary should be interpreted as having the meanings consistent with those in the context of related technology, and should not be interpreted as ideal or excessively formal meanings unless explicitly defined in the present application.

Further, in the description with reference to the accompanying drawings, the same reference numerals are assigned to the same components regardless of the numerals in the drawings, and redundant descriptions thereof will be omitted. In describing the embodiments, when it is determined that a detailed description of related known technologies may unnecessarily obscure the subject matter of the embodiments, the detailed description thereof will be omitted.

Hereinafter, the paint roller of the present invention will be described in detail with reference to examples and drawings. However, the present invention is duly not limited to these examples and drawings.

According to one aspect of the present invention, there is provided a paint roller which includes: a cylindrical roller body having a plurality of holes; and a roller cover surrounding an outer surface of the roller body, wherein the holes are densely distributed at opposite ends of the roller body.

The plurality of holes may be formed on the surface of the roller body, and the number and/or diameter of the holes and spacing between the holes may be variously adjusted depending on the shape and use of the roller, a viscosity of the paint, etc.

The roller cover surrounding the outer surface of the roller body may absorb the paint and apply the absorbed paint to a subject surface. According to use thereof, a roller cover having a flat and smooth surface may be used, a curved one may be used, and a roller cover consisting of hair having a constant length may also be used.

The holes may be densely distributed at opposite ends of the roller body. Specifically, the holes having the same or different diameter may exist at opposite ends more than the center of the roller body, and the holes having the same diameter are preferably disposed at opposite ends of the roller body more than the center of the roller body.

According to an embodiment, the paint roller may include the roller body in which: a support having at least one bent portion; and a hinge portion rotatably coupled to the bent portion of the support are disposed in an inner space of the roller body, as well as a cap coupled to one or opposite sides of the roller body.

The bent portion may refer to a portion of the support that is bent to form a curved portion and a part of the support extending therefrom, and may exist in one or plural according to the shape and use of the roller.

The hinge portion may have an internal passage formed therein, through which the bent portion of the support may pass the inner center of the roller body, and in which the bent portion of the support may freely rotate.

The hinge portion coupled to the bent portion may be disposed in the inner space of the roller body while passing through the inside of the roller body. Herein, the hinge portion coupled to the bent portion may be arranged to be completely coupled with the inner space of the roller body.

The cap may be coupled through the hinge portion, and may serve to secure the support and the roller body during painting.

The hinge portion may be provided with a fitting groove through which the cap can be connected.

According to an embodiment, the support may include: an internal passage connected to a paint feeder, through which the paint is delivered; and a plurality of surface holes through which the delivered paint is ejected.

The support may be used in connection with a handle, may be directly connected to the paint feeder, or may be used in connection with the paint feeder through a hose or pole.

The support may include a plurality of surface holes through which the paint delivered through the internal passage can be ejected, wherein the number and/or diameter of the surface holes and spacing between the surface holes may be variously adjusted depending on the shape and use of the roller.

According to an embodiment, the paint may be delivered in a pressure-feeding manner.

The paint delivered in the pressure-feeding manner may be delivered through the internal passage of the support and then ejected out of the surface holes, and the ejected paint may pass again through the hinge portion and then be ejected out of the holes of the roller body. This method is effective in preventing scattering because the paint is delivered inside and then ejected.

According to an embodiment, a diameter of the cap may be larger than a diameter of the roller cover to prevent lateral scattering.

According to an embodiment, the cap may be free to move within a certain range from a rotation axis, and thus move in a direction away from the surface to be painted during rolling. Therefore, the cap does not interfere with rolling while preventing lateral scattering.

According to an embodiment, the support may be configured to support only one end of the roller body so as to be rotated.

According to an embodiment, the hinge portion may be composed of at least one selected from the group consisting of urethane foam, silicon foam and sponge.

These materials are not only light in weight but also have advantages of easily absorbing and ejecting paint.

According to an embodiment, a length of opposite ends of the roller body may range from 0.1 to 0.5 times the total length of the roller body.

Preferably, the length is 0.1 to 0.4 times, more preferably 0.2 to 0.4 times, and most preferably 0.2 to 0.3 times.

If the length of opposite ends of the roller body is less than 0.1 times the total length thereof, pain supply may not be sufficiently done at the above opposite ends, or a plurality of holes may be seldom densely distributed. On the other hand, if the length exceeds 0.5 times, paint supply may excessively occur on some portions.

According to an embodiment, the holes may be distributed by 50 to 80% in a 20% section in terms of a distance from opposite ends of the roller body.

Preferably, 50 to 70% of total holes are distributed in the 20% section, more preferably 55 to 70% of total holes are distributed in the 20% section, and most preferably 55 to 65% of total holes are distributed in the 20% section.

If the holes are distributed by less than 50% in the 20% section in terms of a distance from opposite ends of the roller body, there may be a problem in that the paint is not evenly distributed due to insufficient supply of paint at opposite ends. Further, if the holes are distributed by more than 80%, there may be a problem in that the paint is excessively supplied to opposite ends whereas the paint is not smoothly supplied to the center portion of the roller body, hence causing uneven distribution of paint during working.

That is, within the above desired hole distribution range, uniformity of the paint may be ensured during work.

According to an embodiment, the number of the holes may be gradually reduced from opposite ends of the roller body toward the center portion.

Therefore, an amount of the ejected paint may gradually decrease toward the center so that the paint distribution on a surface to be painted can become uniform during painting.

According to an embodiment, with regard to the hole, a diameter of the formed hole may increase from the center of the roller body toward opposite ends of the roller.

That is, the number of holes with the same size may increase from the center of the roller body toward opposite ends of the roller. Further, a diameter of the holes may increase from the center of the roller body toward opposite ends of the roller while maintaining the same number of holes. Alternatively, both the number of the holes and the diameter of the holes may increase from the center of the roller body toward opposite ends of the roller.

According to an embodiment, the roller cover may include at least one selected from the group consisting of organic materials, inorganic materials and fabrics.

According to an embodiment, a diameter of the roller body may range from 10 to 80 mm.

Preferably, the diameter of the roller body is 10 to 70 mm, more preferably 20 to 70 mm, more preferably 20 to 60 mm, and most preferably 30 to 50 mm.

When the diameter of the roller body is less than 10 mm, it is difficult to arrange a support for supplying paint and a hinge portion coupled to the support.

Further, when the diameter of the roller body is more than 80 mm, workability during manual work may be reduced due to an increase in size of the roller.

According to an embodiment, a length of the roller body may range from 1,000 to 5,000 mm.

According to an embodiment, a thickness of the roller cover may range from 5 to 50 mm.

Preferably, the thickness of the roller cover is 5 to 40 mm, more preferably 10 to 40 mm, more preferably 10 to 30 mm, and most preferably 15 to 30 mm.

If the thickness of the roller cover is less than 5 mm, there may be a problem in that absorption of the paint is insufficient. Further, when the thickness exceeds 50 mm, there may be a problem in that uniform distribution effects of the paint are deteriorated due to uneven supply of paint to the roller body.

Hereinafter, the present invention will be described in detail with reference to the following examples and comparative examples. However, the technical idea of the present invention is not limited or restricted thereby.

### Example 1

The roller body was manufactured such that 60% of total holes is distributed in a 20% section in terms of a distance from opposite ends of the roller body surface. The holes have the same size of diameter.

After arranging the bent portion of the support to pass through the inside of the manufactured roller body, the paint was delivered in a pressure-feeding manner through an internal passage of the support.

During pressure-feeding, a pressure between 50 to 210 bars was used.

Thereafter, a paint distribution was measured.

### Comparative Example 1

Except that the roller body was manufactured such that holes on the surface of the roller body are uniformly distributed throughout the roller body, the paint distribution was measured in the same manner as described in Example 1.

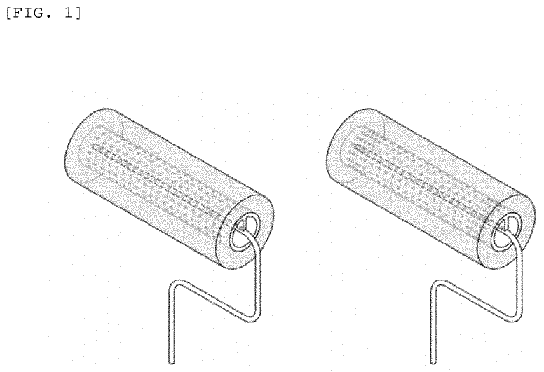

FIG. 1 illustrates an image showing a hole distribution on the surface of the roller body in each of Comparative Example 1 (left) and Example 1 (right), respectively. Referring to FIG. 1, the roller of Comparative Example 1 is shown in the left side, and it could be seen that the holes are uniformly formed throughout the surface of the roller body. On the other hand, the right side shows the roller of Example 1, and it could be seen that holes are densely disposed at opposite ends of the roller.

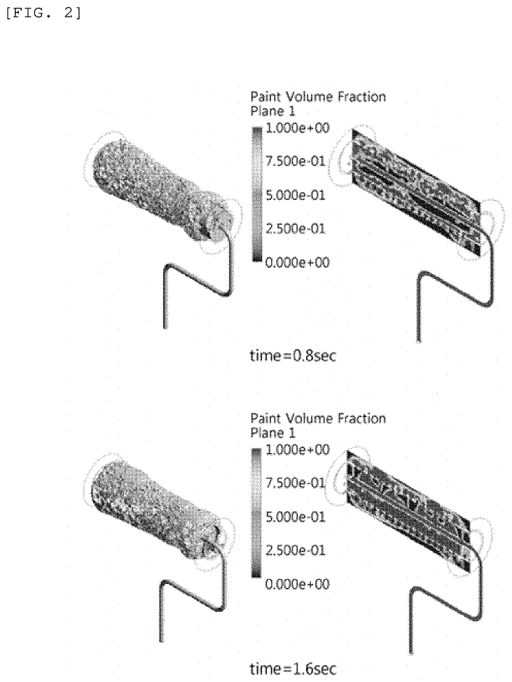

FIG. 2 illustrates a result of observing a paint distribution of the roller body in Comparative Example 1 over time. Referring to FIG. 2, it could be seen from the roller body of Comparative Example 1 that the paint is uniformly distributed over time.

Accordingly, there may be a problem in that the corner portion of the roller may not be sufficiently painted during painting.

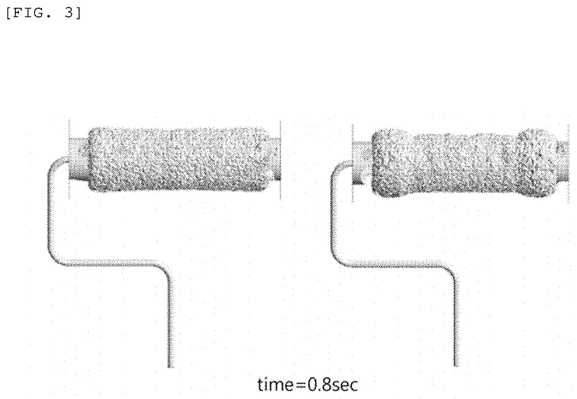

FIG. 3 illustrates a paint distribution of the roller body of each of Comparative Example 1 (left) and Example 1 (right), respectively, 0.8 seconds after paint ejection. Referring to FIG. 3, the roller of Comparative Example 1 on the left side showed that the paint is uniformly distributed throughout the roller body 0.8 seconds after ejection of the paint, whereas the roller of Example 1 on the right side showed that the paint is densely distributed at opposite ends of the roller 0.8 seconds after ejection of the paint.

Accordingly, in the case of Example 1, the painting may be uniformly done by sufficiently supplying the paint to the corner portion.

As described above, although the embodiments have been described by way of the defined drawings, those skilled in the art can apply various technical modifications and variations based on the above embodiments. For example, even if the described techniques are performed in different orders from the above described method, and/or the above components are combined or joined in a form different from those of the above method, or are replaced or substituted by other components or equivalents, appropriate results can be achieved.

Accordingly, other implementations, other embodiments and claims, and equivalents may also fall within the scope of the appended claims.

1. A paint roller, comprising:
a cylindrical roller body having a plurality of holes; and
a roller cover surrounding an outer surface of the roller body,
wherein the holes are densely distributed at opposite ends of the roller body.

2. The paint roller according to claim 1, wherein the roller includes:
the roller body, in which a support having at least one bent portion and a hinge portion rotatably coupled to the bent portion of the support are disposed in an inner space of the roller body; and
a cap coupled to one or opposite sides of the roller body.

3. The paint roller according to claim 2, wherein the support includes:
an internal passage connected to a paint feeder, through which the paint is delivered; and
a plurality of surface holes through which the delivered paint is ejected.

4. The paint roller according to claim 2, wherein a diameter of the cap is larger than a diameter of the roller cover to prevent lateral scattering.

5. The paint roller according to claim 2, wherein the support is configured to support only one end of the roller body so as to be rotated.

6. The paint roller according to claim 2, wherein the hinge portion is formed of at least one selected from the group consisting of urethane foam, silicon foam and sponge.

7. The paint roller according to claim 1, wherein a length of opposite ends of the roller body ranges from 0.1 to 0.5 times the total length of the roller body.

8. The paint roller according to claim 1, wherein the holes are distributed by 50 to 80% in a 20% section in terms of a distance from opposite ends of the roller body.

9. The paint roller according to claim 1, wherein the number of the holes is gradually reduced from opposite ends of the roller body toward the center portion.

10. The paint roller according to claim 1, wherein the holes have a diameter increasing from the center of the roller body toward opposite ends of the roller.

11. The paint roller according to claim 1, wherein a diameter of the roller body ranges from 10 to 80 mm.

12. The paint roller according to claim 1, wherein a length of the roller body ranges from 1,000 to 5,000 mm.

13. The paint roller according to claim 1, wherein a thickness of the roller cover ranges from 5 to 50 mm.
